(19) United States
(12) Patent Application Publication
(10) Pub. No.: US 2013/0168591 A1
(43) Pub. Date: Jul. 4, 2013

(54) VALVE SEAT, VALVE WITH SEAT AND METHOD OF FITTING SEAT TO VALVE

(71) Applicant: David Wade Webster, Monmouth (GB)

(72) Inventor: David Wade Webster, Monmouth (GB)

(73) Assignee: Aker Solutions Singapore PTE LTD, Singapore Science Park (SG)

(21) Appl. No.: 13/822,186

(22) PCT Filed: Nov. 2, 2011
(86) PCT No.: PCT/GB11/52133

§ 371 Date: Mar. 11, 2013

(30) Foreign Application Priority Data
Nov. 3, 2010 (GB) 1018557.7

(51) Int. Cl. F16K 3/02; F16K 99/00

(52) U.S. Cl. CPC F16K 3/0227; F16K 99/00
USPC 251/328; 137/15.23

(57) ABSTRACT

A valve seat (10) for use in a valve incorporating a valve gate is disclosed, the valve seat comprising a valve seat body (12) and a biasing device (14) such as a spring (14), the biasing device being integral with the valve seat body. The biasing device and valve seat body may be welded together or may be formed in a single metal workpiece by a machining, casting or forging process. The valve gate and valve seat cooperate to form a metal-to-metal seal within the valve. At least a portion (15) of the valve seat is typically welded to at least a portion of the valve. A pipeline including at least one valve is also disclosed, as is a method of fitting a valve seat to a valve.

### FIELD OF THE INVENTION

The present invention relates to a valve, especially a valve suitable for pipelines, and more particularly pipeline used for the transportation of oil and gas. The present invention covers the valve itself, and a method for fitting the valve into a pipeline.

### BACKGROUND OF THE INVENTION

Valves are useful components in the control of fluid flow, and allow the fluids to be redirected, the flow-rate to be changed or the fluid blocked entirely from flowing.

In oil and gas pipeline applications, a common type of valve used is the so called gate valve. These generally comprise a fluid inlet, a fluid outlet, and a moveable member or gate deployed there between. The gate can be selectively moved between the fluid inlets and fluid outlets to progressively decrease and then block fluid communication of the two. Often, the gate may be provided with an aperture, and it is the movement of the aperture which is key to the control of fluid flow, as it may be moved directly between the fluid inlet and fluid outlet to provide a fully open position, and progressively out of line with the fluid inlet and fluid outlet to steadily decrease fluid flow, to eventually being moved completely out of line with the two to fully block the fluid flow by providing a barrier between the fluid inlet and fluid outlet.

Valves and pipelines of the type under consideration will be formed from several components joined to one another by suitable means, for example being bolted or welded together. These joins provide a possibility of leakages being found within an operational system.

A valve will typically comprise a valve body, a moveable gate often connected to a control means via rod, and a pair of valve seats. The valve seats are generally annular and are placed within enlarged diameter portions of the through-bore of the valve body, one valve seat being provided on the fluid inlet and the other valve seat located on the fluid outlet side of the gate, and the through-bore of the valve body leading away from each valve seat leads to a flange that connects to a corresponding pipe for fluid transport.

In oil and gas pipeline applications, the fluids will generally be at elevated pressures and/or temperatures. When the gate is in a fully closed position, the fluid inlet pipe will continue to supply fluid and therefore apply a pressure to the valve gate. Since the valve gate and valve seat have to be separate components to allow for the relative movement of the two, an imperfect seal may be at the junction of the two allowing for undesirable leakage. This leakage may flow up between valve seat and valve gate, and then between valve seat and pipe and/or valve seat and valve body, and out of the valve itself. This is obviously undesirable given the potentially hazardous nature of the fluid being transported.

Several prior art solutions exist to mitigate this problem. The first is simple use of elastomeric seals at these junctions. Elastomeric seals may be compressed between components where leakages are likely to occur, and their tendency to bias against both components increases seal efficiency. They are not without their drawback too however, as they tend to perish and require replacement, and also limit working fluid temperature and pressures within the pipeline systems. Typically, non-metallic such as elastomeric seals will limit the working temperature to about 350° Celsius.

Another is the use of a biasing means, usually a metallic seal ring located between the valve body and a rear face of the valve seat, to bias the valve seat against the valve gate. However, non-metallic radial seals are still required to seal the valve at the junction between the valve seat and the valve body to mitigate leakage. However, this brings the disadvantages associated with the use of non-metallic seals described above.

### SUMMARY OF THE INVENTION

According to a first aspect of the present invention there is provided a valve seat comprising a valve seat body and a biasing device, the biasing device being integral with the valve seat body. By integral it will be understood that there is a join between said biasing device and valve seat body, said join being achieved by such attachment methods as welding, or indeed being integrally cast or machined as a single piece. The welding technique may be spot, frictional, arc, laser, electron beam, resistance, flash, or any other technique deemed suitable for the process.

Preferably the biasing device and valve seat body are welded together, but may alternatively be formed from a single metal workpiece put through a forming process such as machining, casting or forging.

Preferably said biasing device comprises a spring, more preferably an annular spring.

Preferably said biasing device comprises an annular sigmoidal spring.

Preferably said annular sigmoidal spring is provided with at least one substantially circular chamfer between two perpendicularly connected sections thereof.

Preferably all perpendicularly connected sections of the sigmoidal spring are connected via substantially circular chamfers.

Preferably a chamfer is provided between an external side wall and an end face of the valve seat, more preferably two chamfers are provided at both end faces and the external side wall of said valve seat.

Preferably the valve seat comprises a metal. More preferably a metal selected from the group consisting of the group of stainless steel and INCONEL (Trade Mark).

Preferably the valve seat body further includes a radially projecting abutment. This radially projecting abutment would be cooperable with a shoulder provided within a suitable valve and limit compression of the biasing device.

Preferably the abutment is annular, disposed around the valve seat.

Preferably the abutment is formed from a separate ring and groove arrangement. More preferably the ring is separate from the valve seat body and is formed from two semi-circles.

According to a second aspect of the present invention there is provided a valve including a valve body and at least one valve seat according to a first aspect of the present invention.

Preferably the valve further includes a valve gate, selectively movable from a closed position, where fluid communication through the valve is blocked, to an open position, where fluid communication through the valve is allowed.

Preferably the valve gate and valve seat cooperate to form a metal-to-metal seal within the valve. This metal-to-metal seal would advantageously be formed in both the open and closed positions, and would provide effective sealing without the need for further sealing means such as elastomeric seals.

Preferably the valve includes a biasing device shoulder cooperable with the biasing device of the at least one valve seat. Preferably the biasing device shoulder is annular, and cooperates with the annular biasing device.

Preferably the valve includes an abutment shoulder cooperable with the radially projecting abutment of the at least one valve seat. Preferably the abutment shoulder is annular, and cooperates with an annular radially projecting abutment.

Preferably the abutment shoulder and the radially projecting abutment cooperate to limit compression of the biasing device against the biasing device shoulder. In use, the biasing device would abut the biasing device shoulder first, upon compression of the biasing device through application of a fluid pressure resulting from the valve being in a closed position, a point would be reached where the radially projecting abutment abutted the abutment shoulder, mitigating further compression of the biasing device.

Preferably the valve seat is welded to the valve body.

According to a third aspect of the present invention there is provided a pipeline including at least one valve according to the second aspect of the present invention.

According to a fourth aspect of the present invention there is provided a method of fitting a valve seat to a valve, said valve seat comprising a valve seat body, a biasing device integral with the valve seat body, a removable abutment and abutment housing; the valve including an abutment shoulder and a biasing device shoulder, the method comprising the steps of partially placing the valve seat within the valve, placing the removable abutment within the abutment housing, and fully placing the valve seat within the valve such that the biasing device abuts the biasing device shoulder. It is preferable that the abutment would be a short distance from full abutment with the abutment shoulder, that short distance defining a compression limit for the biasing device.

### BRIEF DESCRIPTION OF THE DRAWINGS

Reference will now be made, by way of example only, to the accompanying drawings, in which:

FIG. 1 is a side sectional view of a valve seat according to a first aspect of the present invention;

FIG. 2 is side sectional detail view of the biasing device of the valve seat of FIG. 1;

FIG. 3 is a plan view of a valve according to a second aspect of the present invention;

FIG. 4 is a side elevation of the valve of FIG. 3;

FIG. 5 is an end elevation of the valve of FIG. 3;

FIG. 6 is sectional side elevation of the valve of FIG. 3;

FIG. 7 is a detail view of portion BB highlighted in FIG. 6;

FIG. 8 is an end elevation of a stop-ring of the valve of FIG. 3; and

FIG. 9 is a part section side elevation of the stop-ring of FIG. 8.

### DETAILED DESCRIPTION OF THE PREFERRED EMBODIMENTS

A valve seat 10 formed of metal such as stainless steel or ICONEL (Trade Mark) according to the first aspect of the present invention is shown in cross-section in FIG. 1. It comprises a valve seat body 12 and a biasing device 14. The two parts are formed integrally, in this case manufactured by forming the parts separately, before welding the valve seat body 12 permanently to the biasing device 14. Alternatively, the valve seat body 12 and the biasing device 14 can be manufactured from one piece of metal.

The valve seat body 12, and by extension the valve seat 10 itself, is generally cylindrical, and includes an outer sidewall 16 and a front end face 18. The sidewall 16 and end face 18 are connected via a chamfered shoulder 20. Disposed approximately half-way along the sidewall 16 is a circumferential groove 22, which extends around the exterior surface of the valve seat 10, and disposed in a plane perpendicular to the dominant central axis 10a of the valve seat 10.

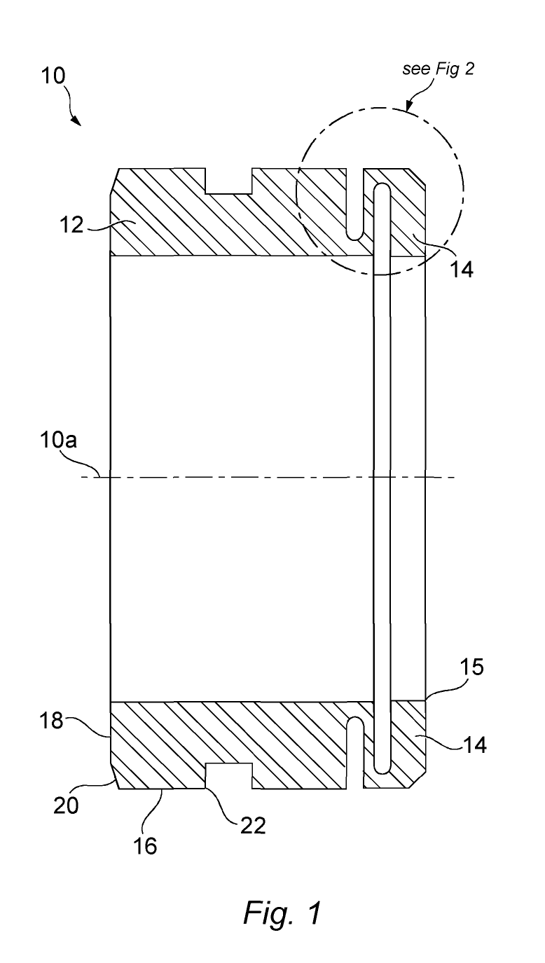

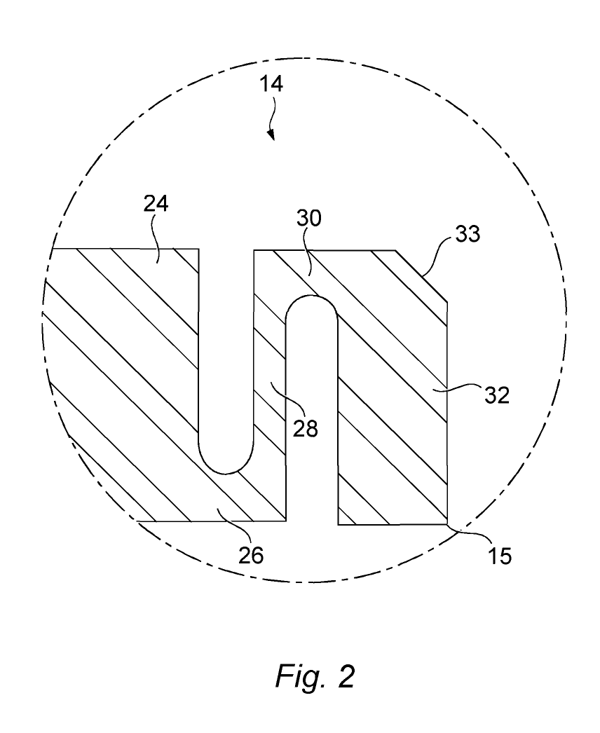

The biasing device 14 comprises a generally annular sigmoidal spring, further detail of which can be viewed in FIG. 2. The biasing device 14 is formed from a first annular portion 24, connected through a first web section 26 to a second annular portion 28, which in turn connects through a second web section 30 to a third annular portion 32.

Being integrally formed with the valve seat body 12, the first annular portion 24 and valve seat body 12 are contiguous. The first web section 26 and second web section 30 attach to the second annular portion 28, respectively, at inner and outer radial extremes, thus forming a sigmoid cross-section. The various sections are contiguous and the connecting surfaces of respective sections and webs are circularly chamfered on the inner surfaces thereof. This chamfering mitigates stress concentration points which could lead to an undesirable permanent plastic deformation of the biasing device. On the outer surface second of the join between web section 30 to third annular portion 32 is a further chamfer 33.

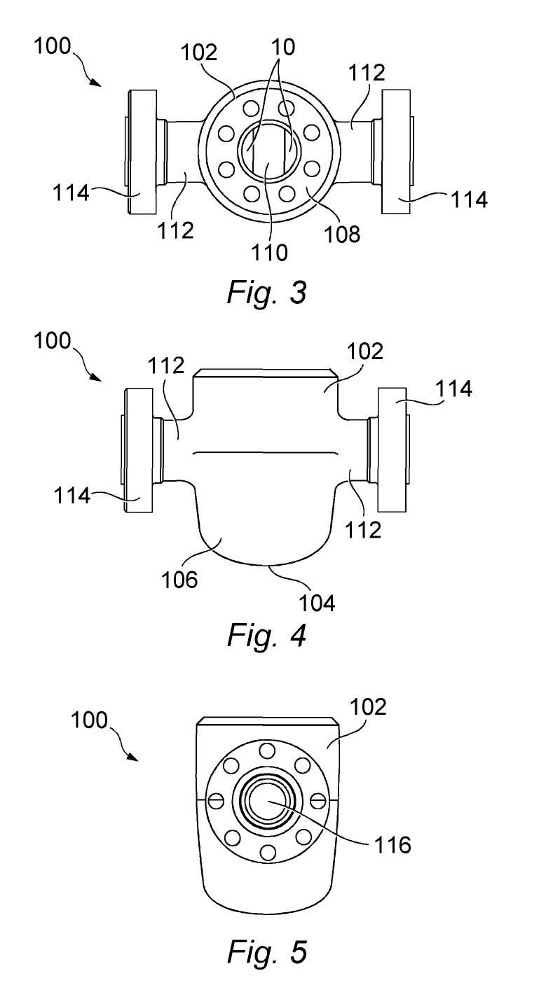

Turning to FIGS. 3 to 5, various external views of a valve 100 according to a second aspect of the present invention are shown. In FIG. 3, inner portions of two valve seats 10 can be viewed.

The valve 100 comprises a valve body 102 formed of metal such as stainless steel or ICONEL (Trade Mark). The valve body 102 is substantially a conical frustum, with the smaller face (and bottom 104 of the valve body 102) of which being rounded, and connected to the valve sidewall 106 via a circular chamfer. The opposite, larger face defines a top connection flange 108, with a top aperture 110 defined therein. The valve sidewall 106 connects to the top connection flange 108 via a square chamfer.

Extending radially outward from the valve sidewall 106, on opposite sides thereof, are two pipe inlets 112. The pipe inlets 112 each connect to pipe connection flanges 114. The connection planes of the pipe connection flanges 114 are perpendicular to the connection plane of the top connection flange 108. Each pipe connection flange 114 defines a pipe inlet aperture 116 at its centre.

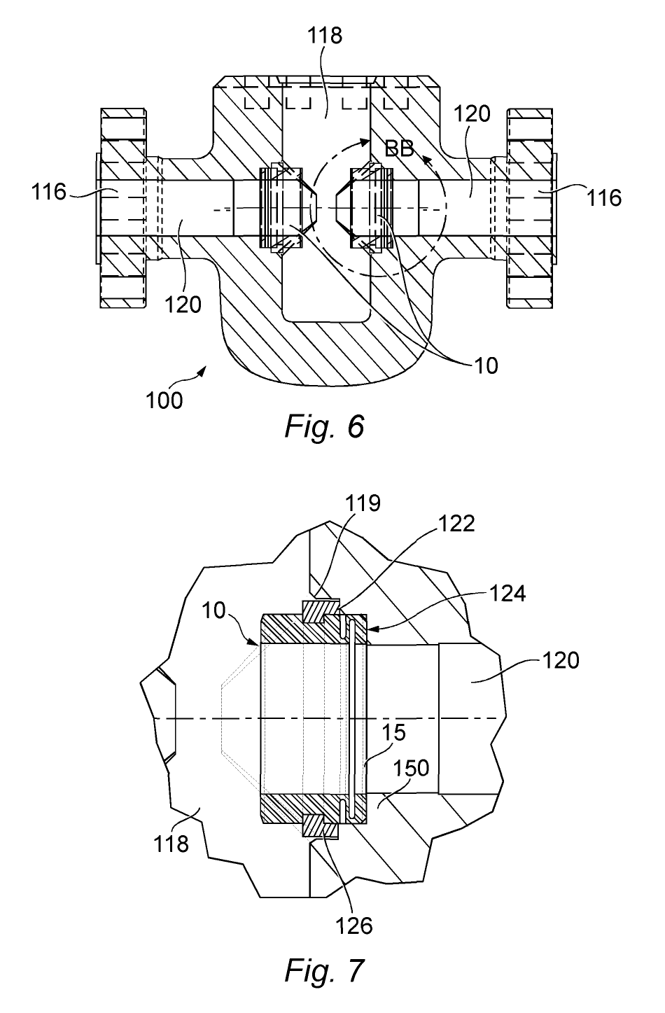

FIG. 6 is a sectional side elevation of the valve 100 showing interior detail. The valve body 102 has three bores defined therein: a top bore 118 which extends from the top aperture 108 down into the valve body 102 towards the bottom 104 but terminating before intersection therewith. Perpendicular to said top bore 118 are two pipe inlet bores 120, which extend from respective pipe inlet apertures 116 towards the opposite pipe inlet aperture. The two pipe inlet bores 120 intercept the top bore 118, with a direct path being formed between the two pipe inlet bores 120. The top bore 118 extends somewhat below the intersection of the two pipe inlet bores 120, and thus a generally cruciform chamber is formed, albeit that only three of the four prongs of the cruciform chamber communicate externally of the valve 102, via top bore 118 and pipe inlet bores 120.

At the junction of each of the pipe inlet bores 120 and the top bore 118, two greater diameter shoulders are formed: a stop-ring shoulder 122 and a biasing device shoulder 124. From the direction of the top bore 118 through to the pipe inlet bore 120, the stop-ring shoulder 122 is first and has the greater diameter of the two, followed by the biasing device shoulder 124, with the lesser diameter of the two. Thus, two “steps” are formed, decreasing in diameter to the diameter of the pipe inlet through-bore 120. A chamfer 119 is provided between top bore 118 and the stop-ring shoulder 122.

A valve seat 10 according to the first aspect of the present invention is deployed at the junction between the top bore 118 and each of the pipe inlet bores 120.

The inner diameter of the biasing device shoulder 124 is only slightly greater than the outer diameter of the biasing device 14 itself, thus a tight, but sliding fit is created, with the third annular portion 32 abutting the terminating portion of the biasing device shoulder 124 once the biasing device 14 is located in its in use position as will be described in more detail subsequently

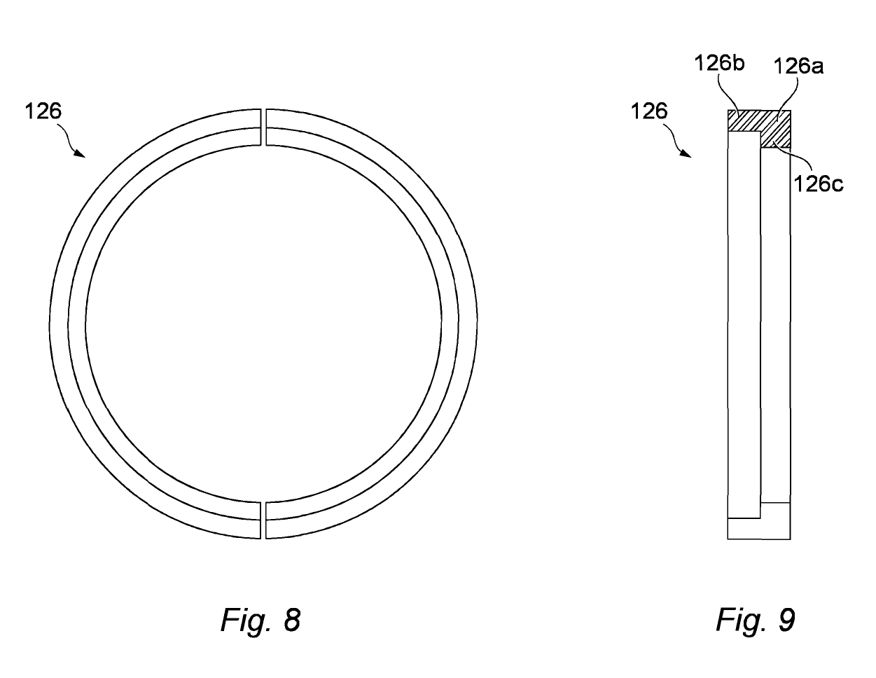

A stop-ring 126 is also provided. The stop-ring 126 is annular with an L-shaped profile, having a greater thickness section 126a and a smaller thickness section 126b. The external diameter of both of these sections is identical, but the inner diameter of the greater thickness section 126a is less than that of the smaller thickness section 126b. A stop-ring lip 126c is therefore defined. Further detail of the stop-ring 126 is shown in FIGS. 8 & 9. The stop-ring 126 is formed in two halves, being two substantially identical semi-circles.

During location of the valve seat 10, it is inserted into the valve 100 via the top aperture 108 and is placed partially within the junction between the pipe inlet bore 120 and the top bore 118. Chamfer 33 aids in this placement. One half of the stop-ring 126 is then placed around the valve seat with the stop-ring lip 126c being placed within the circumferential groove 22. The other half stop-ring 126 is similarly located within the other half of the circumferential groove 22. The valve seat 10 is then pushed toward and into the pipe inlet bore 120.

As shown in FIG. 7, the stop-ring lip 126c is deployed within the circumferential groove 22, with the smaller thickness section 126b being deployed towards the biasing device 14 end of the valve seat 10. The stop-ring 126 is deployed within the stop-ring shoulder 122, although the end face of the smaller thickness section 126 stands proud of the terminating portion of the stop-ring shoulder 122 by a short distance. Therefore, there is a small gap between the end face of the smaller thickness section 126 and the terminating portion of the stop-ring shoulder 122. This gap will be typically in the range of about 0.1 to 0.3 mm, depending on various factors including manufacturing tolerances.

The valve seat 10 is then permanently secured in place by welding corner 15 on the through-bore of the valve seat 10 to corner 150 of the through-bore of the pipe inlet bore 120. In use, a suitable valve actuator (not shown) would be attached to the top of the valve 100 via the top connection flange 108. A valve gate (not shown) typically formed from a metal such as stainless steel or ICONEL (Trade Mark) would extend down through the top bore 118, and be located between the two pipe inlet bores 120 and valve seats 10. A tight, but sliding fit, between valve gate and valve seats 10 is preferred, such that the biasing device 14 is in some compression.

The valve gate is selectively movable and may be provided with a valve gate aperture (not shown) to allow for control of the extent of fluid communication between the two pipe inlet bores 120. Alternatively, the valve gate may be a largely solid member with the end thereof passing between two pipe inlet bores 120 and valve seats 10 to control the extent of fluid communication.

In an open position, the valve gate would be at a position where the gate aperture would be deployed directly between the two pipe inlet bores 120 and valve seats 10, allowing fluid communication between the two. For illustration purposes from the perspective of FIGS. 6 and 7, it will be assumed that the fluid is flowing from left to right. Thus a net pressure exists in that direction. In any event, the end front face 18 of each valve seat 10 is compressed against the respective face of the gate valve around the aperture therein by the biasing force provided by the biasing device 14, and thus a metal-to-metal seal is provided.

As the actuator closes the valve by moving the gate aperture out of position, the effective cross-sectional area available for fluid flow decreases before becoming zero, when the valve is fully closed. Since there is still an upstream pressure acting upon the fluid, the fluid entering the valve 100 from the left hand pipe inlet bore 120 through the left hand valve seat 10, will exert a force upon the valve gate as a result of the fluid pressure. In this embodiment, the various components are metal, so there is a limited but appreciable resilience in the various components. Thus, the valve gate pushes against the right hand valve seat 10 (see FIG. 7) via the end face 18.

Again, being a metal with a limited but appreciable resilience and because of the resilience of the biasing device 14, the third annular portion 32 of the biasing device 14 will be forced further against the terminating portion of the biasing device shoulder 124, and the biasing device 14 will further compress.

As the biasing device 14 is being compressed, the smaller thickness section 126b of the stop-ring 126 moves towards the stop-ring shoulder 122, eventually being in abutment with it. At this point, the fluid pressure is acting against both the reaction force of the biasing device 14 acting against the biasing device shoulder 124 and the reaction force of the stop-ring 126 acting against the stop-ring shoulder 122. Since the stop-ring 126 is of greater thickness and its design does not, in contrast to the biasing device 14, lend itself to adding further resilience to itself over that found in the material itself, the stop-ring 126 acts as a limiter to the compression of the biasing device 14. In other words, further compression of the biasing device 14 is retarded by the stop-ring 126 abutting the stop-ring shoulder 122.

Since valve seat body 12 and biasing device 14 are integral, and a complete seal is provided by the welding between the corner 15 of the biasing device 14 and the corner 150 around the inner circumference of the biasing device shoulder 124, fluid is mitigated from travelling outside the through-bore of the two pipe inlet bores 120 more so than prior art solutions. Further, elastomeric seals are not required at any point in communication with through-bore fluid within the valve 100, eliminating the disadvantages associated with their use.

Modifications and improvements can be made to the embodiments herein before described without departing from the scope of the invention.

For example, instead of a two-piece stop-ring, the stop-ring may be formed in one piece, perhaps with a gap provided at a point on the circumference to aid manipulation and fitting. Further, the stop-ring and groove arrangement may be replaced with an integral lip extending radially from the valve seat body 12.

The biasing device need not be sigmoidal, but may be a simpler or more complex arrangement, for example a Z-shaped arrangement.

Stainless steel or ICONEL (Trade Mark) material may be replaced with a lower grade ferrous (or indeed non-ferrous) material in applications that do not require high-grade, corrosion resistant metals.

As well as the common linear actuator using a rising stem indicator arrangement that would typically attach to the valve 100 via a non-metallic seal, the present invention may also be mated to a rotary actuator driving a non-rising stem. In this way a metal to metal seal can replace the non-metallic stem seal associated with the more normal rising stem arrangement. In this way the potential upper temperature ceiling at which the valve 100 can operate may be further increased. With no non-metallic seals, the next threshold in terms of a temperature barrier becomes the metal tempering range. With a suitable margin in place between the operating temperature and the tempering range of the metals, this will increase the maximum operating temperature normally associated with API gate valve from around 350° F. to around 750° F.

1. A valve seat comprising:
a valve seat body;
a biasing device; and
wherein the biasing device is integral with the valve seat body.

2. The valve seat according to claim 1, wherein the biasing device and valve seat body are welded together.

3. The valve seat according to claim 1, wherein the biasing device and valve seat body comprise a single metal workpiece formed by a machining, casting or forging process.

4. The valve seat according to claim 1, wherein said biasing device comprises a spring.

5. The valve seat according to claim 1, wherein said biasing device comprises an annular spring.

6. The valve seat according to claim 1, wherein said biasing device comprises an annular sigmoidal spring.

7. The valve seat according to claim 6, wherein said annular sigmoidal spring is provided with at least one substantially circular chamfer between two perpendicularly connected sections thereof.

8. The valve seat according to claim 6, wherein all perpendicularly connected sections of the sigmoidal spring are connected via substantially circular chamfers.

9. The valve seat according to claim 1, wherein a chamfer is provided between an external side wall and an end face of the valve seat,

10. The valve seat according to claim 1, wherein two chamfers are provided at both end faces and the external side wall of said valve seat.

11. The valve seat according to claim 1, wherein the valve seat comprises a metal.

12. The valve seat according to claim 1, wherein the valve seat comprises a metal selected from the group consisting of the group of stainless steel and INCONEL®.

13. The valve seat according to claim 1, wherein the valve seat body further includes a radially projecting abutment.

14. The valve seat according to claim 13, wherein the radially projecting abutment is annular, disposed around the valve seat.

15. The valve seat according to claim 13, wherein the radially projecting abutment is formed from a separate ring and groove arrangement.

16. The valve seat according to claim 15, wherein the ring is separate from the valve seat body and is formed from two semi-circles.

17. A valve including a valve body and at least one valve seat according to claim 1.

18. The valve according to claim 17 further including a valve gate, selectively movable from a closed position, where fluid communication through the valve is blocked, to an open position, where fluid communication through the valve is allowed.

19. The valve according to claim 18, wherein the valve gate and valve seat cooperate to form a metal-to-metal seal within the valve.

20. The valve according to claim 17, wherein the valve includes a biasing device shoulder cooperable with the biasing device of the at least one valve seat.

21. The valve according to claim 20, wherein the biasing device shoulder is annular, and cooperates with the annular biasing device.

22. The valve according to claim 17, wherein the valve includes an abutment shoulder cooperable with the radially projecting abutment of the at least one valve seat.

23. The valve according to claim 22, wherein the abutment shoulder is annular, and cooperates with an annular radially projecting abutment.

24. The valve according to claim 22, wherein the abutment shoulder and the radially projecting abutment cooperate to limit compression of the biasing device against the biasing device shoulder.

25. The valve according to claim 17, wherein at least a portion of the valve seat is welded to at least a portion of the valve.

26. A pipeline including at least one valve according to claim 17.

27. A method of fitting a valve seat to a valve, said valve seat comprising a valve seat body, a biasing device integral with the valve seat body, a removable abutment and abutment housing, the valve including an abutment shoulder and a biasing device shoulder, the method comprising the steps of:
partially placing the valve seat within the valve;
placing the removable abutment within the abutment housing; and
fully placing the valve seat within the valve such that the biasing device abuts the biasing device shoulder.

28. The method of fitting a valve seat to a valve according to claim 27, wherein the abutment is a short distance from full abutment with the abutment shoulder, that short distance defining a compression limit for the biasing device.
